(19) United States
(12) Patent Application Publication
(10) Pub. No.: US 2004/0089096 A1
(43) Pub. Date: May 13, 2004

(54) Vibration resistive steering wheel and method

(76) Inventors: William E. Bostick, St. Clair, MI (US); William B. Cox JR., Berkley, MI (US); Michael A. Halifax, Fort Gratiot, MI (US); Anderson G. Lowrie, Port Huron, MI (US)

Correspondence Address: Laurence C. Begin, Dinnin & Dunn, P.C., Suite 500, 2701 Cambridge Court, Auburn Hills, MI, 48326, US

(21) Appl. No.: 10/657,831

(22) Filed: Sep. 9, 2003

Related U.S. Application Data
(63) Continuation-in-part of application No. 10/223,137, filed on Aug. 19, 2002.
(60) Provisional application No. 60/409,290, filed on Sep. 9, 2002.

(51) Int. Cl. B62D 1/04

(52) U.S. Cl. 74/552

(57) ABSTRACT

A steering wheel (310) for a motor vehicle includes a core member with a circular rim (312). At least one dampening element (314) is attached to the rim (312) and is supported and sprung in a sleeve (318) by at least one spring element (316). A method of manufacturing a steering wheel (310) is also provided, the method including steps of providing a steering wheel core member (312), and securing a sleeve (318) having at least one dampening element (314) supported and sprung therein to the core member (312). A method of optimizing vibration in a vehicle steering wheel assembly is further provided.

### CROSS-REFERENCE TO RELATED APPLICATIONS

This application claims the benefit of the filing date of Provisional Application No. 60/409,290, filed on Sep. 9, 2002. This application is also a continuation-in-part of co-pending U.S. application Ser. No. 10/223,137 having a filing date of Aug. 19, 2002.

### TECHNICAL FIELD

The present invention relates generally to steering wheels and vehicle steering assemblies, and more particularly to a steering wheel or steering assembly having increased resistivity to vehicle and rotational vibration.

### BACKGROUND OF THE INVENTION

A longtime goal of automotive designers has been minimizing vibration in various vehicle systems during operation. Reductions in vibration can offer the advantages of less wear and tear on vehicle parts and higher operating efficiency due to less energy wasted by vibrating components, as well as greater comfort for the operator. Because structural and functional details of automobiles differ greatly among different vehicle lines and models, vibration suppression criteria for one vehicle may differ from that of other vehicles. Moreover, vibrational characteristics change when new system or structural technologies, and even new styling designs are incorporated into existing vehicle models.

Of particular interest to designers has been the development of vibration dampeners in vehicle steering wheels. Lessening vibrations communicated through the steering system can reduce operator fatigue and vehicle noise, and enhance overall driving enjoyment. Some methods of reducing vibration in the steering system have focused on the use of damper weights to absorb vibrations communicated through the steering column, and various methods are known in the art. In one approach, resilient members are used to join an airbag module to the steering wheel, thereby allowing the airbag module to act as a mass damper. In this approach, however, such systems require a relatively heavy airbag module to effectively suppress rotational vibrations. Other systems utilize a mass damper directly associated with the steering column. Again, such systems are relatively complex and require a relatively large mass.

### SUMMARY OF THE INVENTION

In one aspect, a steering wheel for a motor vehicle is provided preferably having a dampening element positioned in a sleeve and secured about a steering wheel core. At least one spring member preferably extends about a periphery of the dampening element and resiliently supports the dampening element in the sleeve. More preferably, a plurality of spring members is provided, and symmetrically positioned about the dampening element. The sleeve preferably insulates the dampening element and spring member assembly during the foam mold steering wheel manufacturing process, thereby resulting in a suspended sprung mass or dampener within the steering wheel interior.

In another aspect, a method of optimizing vibration in a vehicle steering wheel assembly is provided. The method preferably includes the steps of forming a steering wheel core member having a substantially circular rim portion, the core member being connectable to a vehicle steering system, and positioning at least one dampening element in a sleeve, wherein the dampening element is resiliently supported in the sleeve by at least one spring element. The method further preferably includes the step of securing the sleeve about the rim portion and rotationally fixing the sleeve relative thereto. Resilient support of the dampening element by the spring element(s) facilitates resilient and relative displacement between the sleeve and dampening element during vibration of the steering wheel assembly, thereby attenuating vibrations imparted thereto from the vehicle steering system.

### BRIEF DESCRIPTION OF THE DRAWINGS

FIG. 1 is a partial cross-sectional view of a steering wheel according to a first constructed embodiment of the present invention.

FIG. 2 is a partial elevational view of a steering wheel according to a constructed embodiment of the present invention similar to FIG. 1.

FIG. 3 is a partial cross-sectional view of a steering wheel according to a second constructed embodiment of the present invention.

FIG. 4 is a partial cross-sectional view of a steering wheel according to a third constructed embodiment of the present invention.

FIG. 5 is a partial cross-sectional view of a steering wheel according to a fourth constructed embodiment of the present invention.

### DETAILED DESCRIPTION

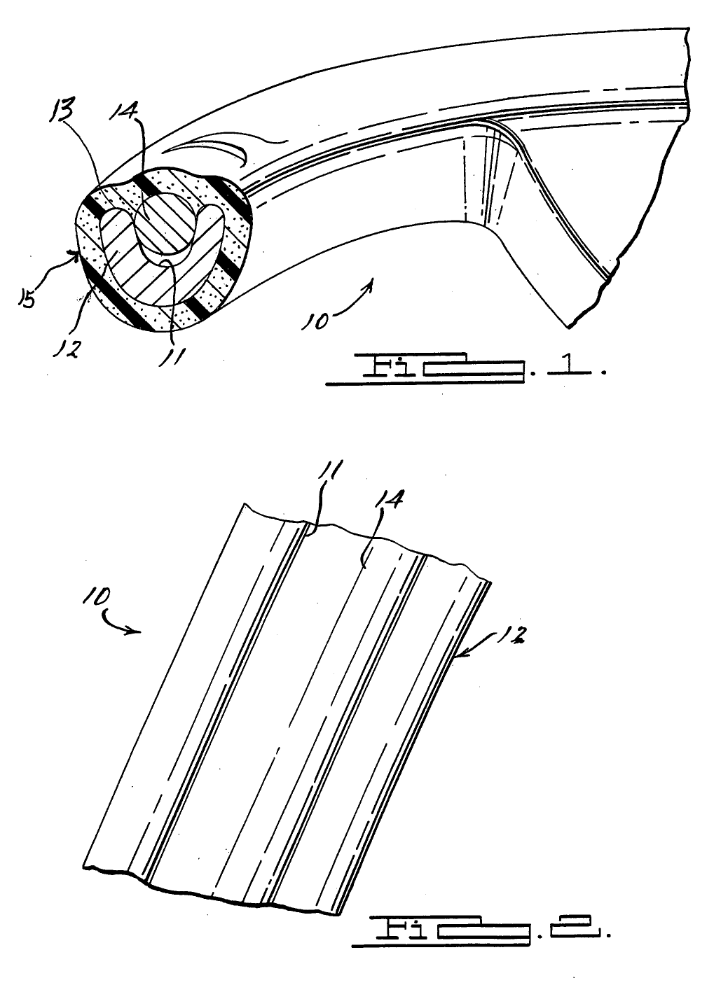

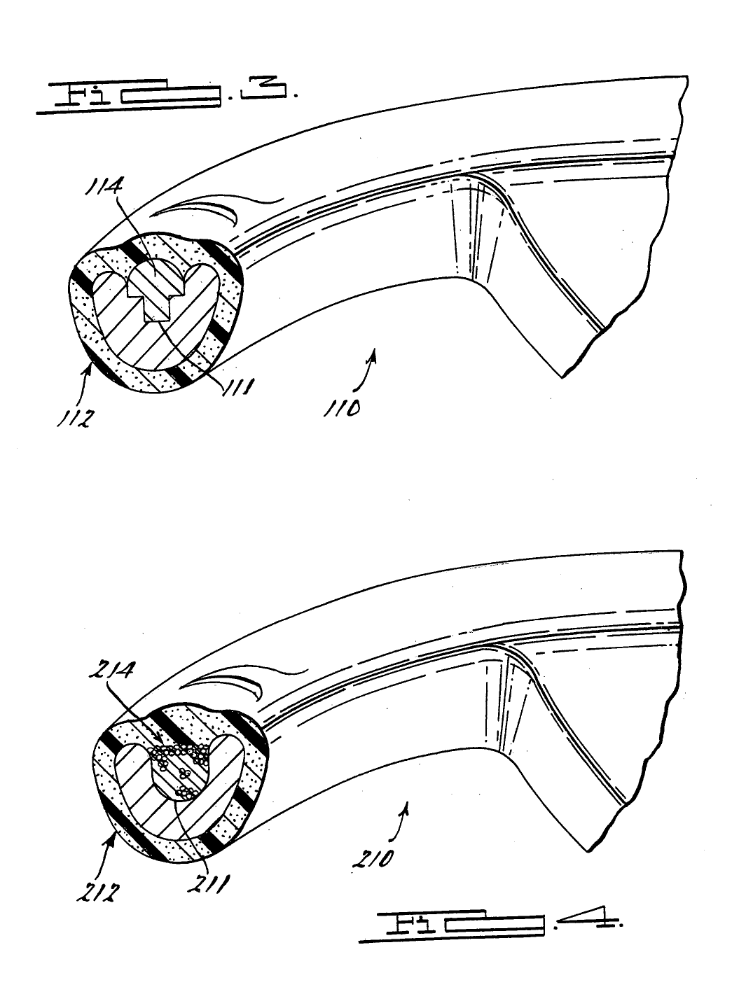

Referring to FIGS. 1 and 2, there are shown partial views of a steering wheel 10 according to a preferred embodiment of the present invention. Steering wheel 10 has a core 12 with a substantially circular rim 13. The core 12 is preferably die cast or machined from metal. A channel 11 is preferably formed within the rim 13 for placement of a dampening element as explained below. A dampening element 14 is secured about or within rim 13 and is preferably positioned at least partially within channel 11, and secured therein. In a preferred embodiment, the steering wheel core is die cast aluminum or magnesium, and is formed as a unitary core member having a plurality of spokes (not shown) connecting core 12 to a central body (not shown), and mounted to a vehicle steering system in a conventional manner. When fully assembled, steering wheel 10 is preferably covered with a known covering material, for example plastic, leather, or fabric. Securing dampening element 14, preferably formed of a relatively dense material, to rim 13 increases the moment of inertia of the steering wheel as well as the rotational mass moment of inertia, increasing its resistance to rotational vibration. It should be appreciated that actually providing a channel 11 in rim 13 is not critical for purposes of the present invention, however, a channel helps in positioning and retaining the dampener weight, and thus represents a preferred embodiment. Those skilled in the art will appreciate that securing dampener 14 “about” rim 13 encompasses a wide variety of securing means, and it is not necessary that dampener 14 be actually attached to rim 13 itself.

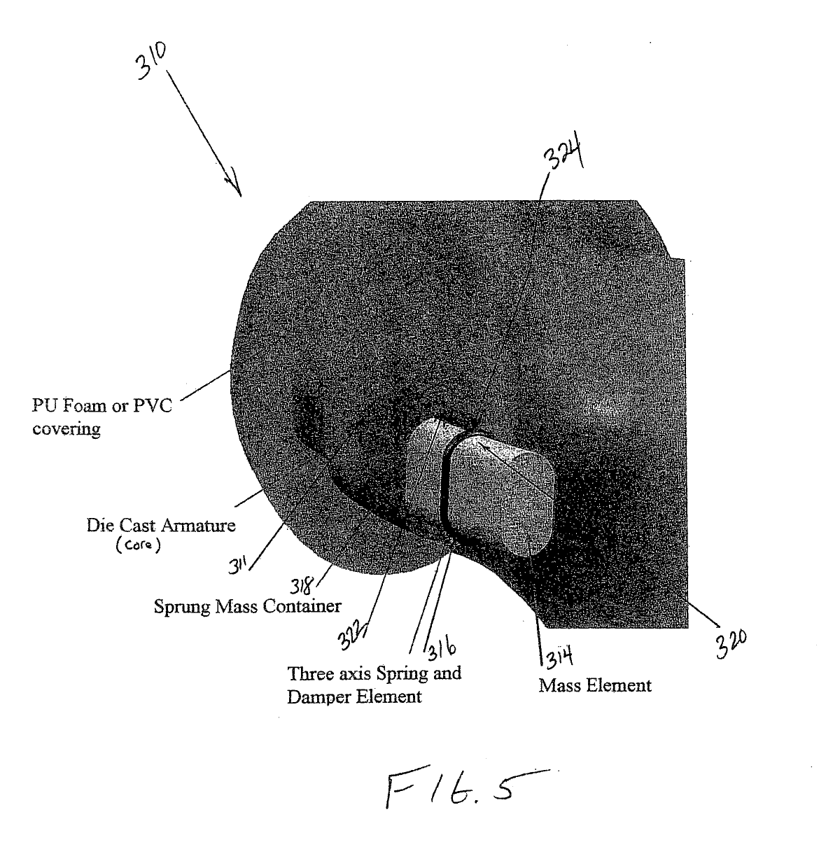

Channel 11 is preferably substantially U-shaped in cross-section, but might vary considerably without departing from the scope of the present invention. In a preferred embodiment, channel 11 is molded when casting the unitary core member; however, the channel might instead be machined. Alternatively, the entire rim 13 might be manufactured as a separate piece, and attached to spokes and a central mount portion to assemble the core member 12. Rather than a U-shaped channel, rim 13 might have, for example, a T-shaped, square, semi-circular, or V-shaped channel. FIG. 3 illustrates a T-shaped channel 111 mounted in a steering wheel 110. Returning to FIGS. 1 and 2, dampener 14 can similarly be formed having a variety of cross-sectional geometries, preferably designed to substantially match the cross section of channel 11, wherein dampener 14 is positioned. In a preferred embodiment, channel 11 is continuous around circular rim 13; however, it should be appreciated that rim 13 might have a plurality of channels, separated by filled-in regions, positioned circumferentially around rim 13. One preferred die casting process leaves portions of the channel filled wherein the die is gated for molten metal delivery. Dampener 14 is preferably a complete or partial ring made from a material denser than core 12, for instance lead, steel, tungsten, or some other metal. The dampening element(s) 14 may also be a sufficiently dense non-metallic material, for example, a dense polyvinyl chloride (PVC). Various designs are possible, and rather than a ring or partial ring, dampener 14 might instead comprise a plurality of pieces preferably positioned substantially symmetrically around steering wheel 10. Although the dampening element is preferably substantially radially symmetrical about the rim, alternative constructions are contemplated in which the mass may be asymmetrically oriented about the center of the wheel. In yet another embodiment, two partial circle members are utilized rather than a continuous ring. In this embodiment, the two distinct members can be positioned in channel 11, allowing the discontinuous dampener structure 14 to accommodate the solid regions resulting from the molding process and the gates in the die. In the present description, dampener 14 is referred to in the singular, however, it should be appreciated that the descriptions herein are equally applicable to embodiments employing multiple dampeners 14. In still other contemplated embodiments, as illustrated in FIG. 4, a channel 211 is filled with a metallic powder or metal grindings/turnings 214 that can be pressed in the channel 211 to retain the material therein or, alternatively, heated and pressed to form dampening members that can be manipulated similar to dampener members/rings, as described above.

Returning to FIGS. 1-4, a variety of different methods of mounting dampener 14 about rim 13 is contemplated. In a preferred embodiment, dampener 14 is mounted substantially within channel 11; however, it might be mounted wholly or only partially within channel 11 depending on the dimensions of the dampener 14 and the channel 11 itself. Thus, as used herein, the term “within” will be understood to mean fully, as well as partially in the channel 11. Moreover, as described above, the use of a channel is not critical, and a weighted dampener member might be secured to the steering wheel rim 13 by other means. For example, rather than a channel 11 in the rim 13, the rim 13 itself might be formed with a rounded outer surface matable with a channel in the dampener 14. Further, a channel type of interface is not necessary at all. The dampening element 14 might, for instance, be formed with a flattened side that could be positioned flush with a flattened portion of the rim 13. The dampening element 14 could be attached to the rim 13 with fasteners, adhesive, or even spot welded. Various additional alternatives are possible, and those skilled in the art will appreciate that a great variety of different shaped rims and dampeners might be used without departing from the scope of the present invention. “Vibrational communication,” as used herein, will be understood to mean that vibrations are communicated between two or more structures.

In a preferred mounting method, the rim 13 (and core member 12) with the associated or inserted dampener 14 are positioned in an injection mold (not shown) with channel 11 facing upward. Next, a multiple-component elastomeric foaming material is delivered to the mold, in a process known in the art as reaction injection molding. The foam material, or adherent, is preferably a polyurethane foam or composite as known in the art, and adheres to dampener 14 and to rim 13, holding dampener 14 in its desired position and providing a resilient coating layer on the exterior of the wheel. Stated another way, the foam mold process may be used to “rotationally fix” the rim 13 to the dampener element 14. The article may subsequently be painted, or covered with leather, plastic, etc. to finish the steering wheel. It should further be appreciated that dampener 14 is preferably formed from a material having a melting point sufficient to withstand the temperature during reaction injection molding, which generally ranges from 100° C. and above, and more specifically from 100° C. to 120° C. An illustrative example of a suitable injection molding method is described in U.S. Pat. No. 6,386,063 to Hayashi et al., herein incorporated by reference. Those skilled in the art will appreciate that a wide variety of known adhesives and elastomeric materials could be used as the steering wheel covering/dampener-retaining material without departing from the scope of the present invention.

Dampener 14 is thus secured in the channel 11 by the foam, however, the preferably flexible, resilient nature of the foam can impart a degree of freedom of movement to dampener 14. Dampener 14 can be mounted in channel 11 such that the dampener piece(s) are in continuous contact with the rim 13, allowing translational and rotational vibrations from the core to be transmitted directly to the dampener.

Alternatively, a layer of foam or other resilient material might be disposed between the dampener and the core, allowing the foam to absorb energy before transmitting the energy to the dampener. Such a design allows some of the energy of rotational vibration to be absorbed by expansion and contraction of the foam. Likewise, the use of resilient foam also increases resistance to translational vibration, expansion and contraction of the foam allowing the dampener to suppress non-rotational, i.e. linear vibrations. Other methods of affixing (or “rotationally fixing”) dampener 14 to the core member are contemplated, including mechanical attachment(s), such as rivets or screws, or tabs attached to rim 13 that can be bent over to secure dampener 14 in place. In an embodiment utilizing tabs to hold dampener 14 in place, the tabs may be formed integrally with rim 13 in a die casting process, or they may be attached separately after forming rim 13. Still other contemplated methods of affixing dampener 14 to rim 13 include press-fitting dampener 14 into channel 11, or crimping rim 13 to secure dampener 14 therein or thereabout.

It is believed that adding weight around the rim of steering wheel 10 increases the polar mass moment of inertia of the wheel, increasing resistance to rotational vibration in the steering wheel. When mass is added at the exterior of the wheel, the rotational inertia of the wheel increases more than when an equal mass is added closer to the axis of rotation of the wheel (center body). The value of rotational inertia for a hoop rotated about a cylinder axis, similar to the rim of a steering wheel rotated about the steering column, can be expressed by the equation:

I=MR²

“I” is the rotational inertia, “M” is the mass of the rim (hoop), and “R” is the radius of the hoop. Although this expression only approximates the result of attaching the instant dampener 14 to the steering wheel, those skilled in the art will appreciate that rotational inertia generally increases with the square of the distance between the point where the mass is added and the axis of rotation. In many steering wheel designs, the actual axis of rotation is not at the exact center of the wheel, however, this mathematical relationship is generally applicable. Therefore, with greater rotational inertia, i.e. greater force required to initiate or reverse rotation of the steering wheel, the wheel has an increased resistance to rotational vibration. Because mass is added only where it has the most efficacious dampening effect, at the rim, the total mass that must be added to reduce vibration is minimized. By minimizing the required mass, the natural frequency of vibration of the steering wheel is not lowered as much as in systems that, for example, utilize a relatively larger mass, added closer to the center of the wheel. It has been a goal of designers to avoid constructing steering wheel systems with a natural vibration frequency close to natural frequencies encountered in operation of the vehicle as a whole, for instance that of the engine or the vehicle itself. As presently understood, the present invention allows a minimal amount of mass to be added, maintaining the natural frequency of vibration of the steering wheel at a value different from the vehicle or engine natural vibration frequencies, thereby minimizing undesirable resonance vibration of the steering wheel. Furthermore, avoiding the need to add an excessive amount of mass is less expensive and reduces the risk of significantly altering the crash performance of the steering system and related components, a problem that can arise where relatively large masses are added to the airbag module, or elsewhere close to the wheel's axis of rotation.

A problem related to rotational vibration involves the phenomenon known in the art as “lumpy return.” When a vehicle is directed into a turn, the steering wheel's subsequent return to its center position may take place through a series of jerky or bumpy motions rather than the desired smooth action. Adding mass to the wheel, particularly the addition of mass at the exterior, reduces the degree to which variations in the road surface, as well as fluctuations in the power steering operation, can reduce the smoothness of the wheel's return to its center position. Likewise, adding mass to the steering wheel increases the resistance of the wheel to translational, i.e. non-rotational vibrations.

In a related aspect, the present invention provides a tunable method of optimizing, e.g. increasing resistivity to, rotational vibration in a vehicle steering wheel. In different vehicle lines, and even in vehicles of the same make and model, subtle differences in components and production may cause optimal rotational vibration characteristics to vary. In a preferred embodiment, dampeners having various densities, sizes, configurations, and weights are made available for attachment to steering wheel 10. Simulation apparatuses, well known in the art, are used to simulate, for example, smooth road, bumpy road, and turning conditions encountered by a vehicle steering system. Thus, objective measurements of vibration amplitude and frequency can be recorded under varying simulated conditions. During testing, different rings or alternative dampening structures are inserted into the channel 11, giving the steering system greater or lesser resistance to rotational vibration, and greater or lesser natural vibration frequencies. In this fashion, the individual ring(s) or dampeners imparting vibration characteristics appropriate to a particular vehicle may be selected. A preferred testing sequence involves assembling a steering wheel apparatus without a dampening insert 14, then mounting the steering apparatus on the simulator to determine the vibration characteristics under different conditions. The next step, if necessary, involves mounting the heaviest of a plurality of available dampeners into the channel 11, then performing a second series of tests to determine the vibration characteristics with the weighted steering wheel. If satisfactory, the “heavy” dampener will be used for that vehicle, or line of vehicles. If unsatisfactory, the various other dampeners will be tested with the steering apparatus until the optimum dampener(s) is/are determined. A test rig for assessing rotational vibration characteristics of a steering wheel, and a method of doing so is described in Giacomin, J., Shayaa, M. S., Dormegnie, E. and Richard, L. 2001, A Frequency Weighting Curve For The Evaluation Of Steering Wheel Rotational Vibration, Submitted to the Journal of Sound and Vibration, and viewable on the internet at www.shef.ac.uk/mecheng/dynam/ra/human.htm. Other methods of determining the appropriate dampeners to insert into a particular steering wheel are contemplated, such as actual vehicle operation tests, and subjective data obtained from test drivers. For example, rather than the use of a simulation apparatus, drivers might operate a vehicle under different conditions and at different speeds, allowing experimenters to select the optimum dampener based on the stated preferences and experience of the test drivers. In some instances, the steering system may be fully assembled into the vehicle, with the exception of the dampener 14. Driving tests can be undertaken with various weighted rings and dampener designs held in the steering wheel, and a dampener permanently molded in place only after the optimum dampener is selected.

In yet another embodiment, a steering wheel 310 as shown in FIG. 5 includes at least one spring member 316 and preferably a plurality of spring members 316 positioned about the periphery of a dampener 314, thereby effectively springing the mass or the dampener 314. As in the other embodiments, the dampener 314 may be a full ring housed within a channel 311 of the steering wheel core or rim 312. In this embodiment, the mass 314 is preferably but not necessarily, formed from a material denser than the steering wheel core 312 wherein the mass 314 might be formed from lead, zinc, or tungsten, for example, and the core might then be formed from carbon steel or steel. Alternatively, the mass 314 might be two half circles positioned in opposite halves of the steering wheel 310. Or, the mass 314 might comprise a plurality of segments oriented symmetrically about the core 312 and within the core channel 311. At least one spring member 316 is positioned about the periphery of the mass 314, in intimate contact therewith. In a preferred embodiment, a plurality of “O”-rings or polymeric spring members 316 is snugly and symmetrically oriented about the mass 314 periphery. A sleeve 318, is preferably formed from a rigid material or polymer such as polyvinylchloride and encapsulates or insulates the mass and spring assembly 320 during the steering wheel foam mold process. An inner wall 322 of the sleeve 318 additionally provides a torsional surface wherein an outer surface(s) 324 of the spring member(s) 316 interfaces therewith and thus exerts a torque on the spring member 316 as vibrations occur during vehicle operation. The dampener 314 may be rotationally fixed to the rim 313 or core 312 as described relative to other embodiments, by foam mold for example.

Accordingly, the mass 314 is supported by the spring members 316 and therefore suspended within the sleeve 318 about the periphery of the steering wheel 310. Resonance frequency is therefore attenuated along a three-dimensional profile and torsional vibration is attenuated as well.

As with the other embodiments, the fourth embodiment shown in FIG. 5 may be tuned to accommodate various vibrational patterns particular to a given vehicle. As presently understood, determining the optimum amount of spring members 316 employed about the mass 314 is best accomplished through an iterative method. Stated another way, the resonant and torsional vibrations are best attenuated by simply employing one spring member 316 about the dampener or mass 314, securing the steering wheel 310 within a known testing apparatus (those used by Ford or General Motors for example), and then determining the resonant and torsional vibrations attendant therewith. Accordingly, the vibrations inherent within any steering wheel assembly 320 may be inhibited or optimized by simply adding additional spring members 316 and then repeating the test until the vibrational frequencies fall within customer specifications. In conjunction with varying the number of spring elements 316, the vibrations may also be attenuated by varying the materials used for the spring and thus varying its inherent spring-like properties, and/or by varying the materials used in the dampener 314, for example.

Further still, the spring elements 316 may be varied in size to attain the desired vibrational characteristics in the steering wheel. For example, relatively larger O-rings may deform more against the interior walls of sleeve 318 than relatively smaller O-rings, and will accordingly “spring” the dampener 314 differently than the smaller O-rings. Stated another way, the relative displacement the O-rings allow between dampener 314 and sleeve 318 while undergoing a given vibration may vary depending upon the width of the selected O-rings, as well as other characteristics thereof such as hardness.

As with foregoing described embodiments, the density and/or number of dampening elements can be varied in the sprung mass design. Thus, dampeners having relatively greater or lesser densities can be incorporated into sleeves in accordance with the present invention, then the different mass sleeves can be mounted onto a steering wheel core, and vibrational characteristics tested.

The O-rings are preferably made of a resilient polymer such as urethane or polyurethane and may be provided from well known sources such as Freudenberg NOK or Dupont. The sleeve 318 is preferably made from PVC, for example, or some other rigid material that like the material of the “O-rings” or spring members 316, can withstand the temperatures attendant to the foam mold steering wheel manufacturing process.

The present description is for illustrative purposes only, and should not be construed to limit the breadth of the present invention in any way. Thus, those skilled in the art will appreciate that various modifications might be made to the presently disclosed embodiments without departing from the scope of the invention, as defined above and in terms of the claims set forth below.

What is claimed:

1. A steering wheel for a motor vehicle comprising:
a core member having a substantially circular rim;
at least one dampening element secured about or within said rim in vibrational communication therewith, said dampening element comprising a periphery;
at least one spring member extending about said periphery thereby supporting said dampening element; and
a sleeve positioned about said dampening element, thereby covering the dampening element within said steering wheel.

2. The steering wheel of claim 1 further comprising a plurality of spring members symmetrically oriented about said dampening element.

3. The steering wheel of claim 2 wherein said spring member is an O-ring.

4. The steering wheel of claim 2 wherein said plurality of spring members is a plurality of O-rings.

5. The steering wheel of claim 1 wherein said dampening element has a density greater than the density of said core member.

6. The steering wheel of claim 1 wherein said spring member is formed from a resilient material or polymer.

7. The steering wheel of claim 1 wherein the substantially circular rim comprises a channel substantially complementary with said dampening element.

8. A method of manufacturing a steering wheel comprising the steps of:
providing a steering wheel core member having a circular rim;
providing at least one dampening element having a periphery;
positioning at least one spring member about the periphery of the dampening element;
positioning the at least one dampening element in a sleeve, the spring member resiliently supporting the dampening element therein; and
securing the sleeve about or within the rim of the steering wheel core member, thereby providing resilient suspension of the dampening element relative to the steering wheel core member.

9. The method of claim 8 further comprising the steps of:
positioning the core member and sleeve in a molding apparatus; and
delivering a flowable curable material into the molding apparatus, wherein the cured material adheres to the sleeve and core member, and is insulated from the dampening element and at least one spring member by the sleeve.

10. The method of claim 8 wherein the at least one dampening element comprises a plurality of dampening elements secured in at least one sleeve about the rim of the core member.

11. The method of claim 8 wherein the at least one spring member comprises a plurality of spring members.

12. The method of claim 10 wherein the at least one spring member comprises a plurality of spring members.

13. The method of claim 12 wherein the at least one spring member comprises a plurality of O-rings.

14. The method of claim 8 wherein the steering wheel rim comprises a channel for receipt of the sleeve.

15. A steering wheel formed according to the method of claim 8.

16. A method of providing for optimal vibration in a vehicle steering wheel assembly comprising the steps of:
forming a steering wheel core member having a substantially circular rim portion, the core member being connectable to a vehicle steering system;
providing at least one dampening element having a periphery;
positioning at least one spring element about the periphery of the at least one dampening element to form at least one spring assembly;
positioning the at least one spring assembly in a sleeve, wherein the at least one dampening element is resiliently supported in the sleeve by the at least one spring element;
rotationally fixing the sleeve about the rim portion;
wherein resilient support by the at least one spring element of the at least one dampening element facilitates resilient relative displacement between the sleeve and dampening element during vibration of the steering wheel assembly, thereby attenuating vibrations imparted thereto from the vehicle steering system.

17. The method of claim 16 wherein the at least one dampening element is formed from a material having a density greater than a density of the core member, thereby imparting an increased inertial resistance to vibration of the steering wheel assembly.

18. The method of claim 16 further comprising the steps of:
providing a plurality of sleeves, each having a dampening element with a different mass resiliently supported therein;
measuring vibration of the steering wheel assembly with each of the selected sleeves secured to the steering wheel core; and
selecting a sleeve from the plurality of sleeves to impart optimal vibration resistance to the steering wheel assembly based on vibrational characteristics imparted to the steering wheel assembly when secured thereto.

19. The method of claim 16 further comprising the steps of:
positioning a first number of resilient spring elements about a periphery of a dampening element;
placing the dampening element with the first number of resilient spring elements in a sleeve, and securing the sleeve to a steering wheel core;
measuring vibration of the steering wheel core with the sleeve mounted thereon;
positioning a second number of resilient spring elements about a periphery of a dampening element;
placing the dampening element with the second number of resilient spring elements in a sleeve, and securing the sleeve to a steering wheel core;
measuring vibration of the steering wheel core with the sleeve mounted thereon; and
selecting a number of spring elements for positioning on the dampening element to impart optimal vibration resistance to the steering wheel assembly based on vibrational characteristics imparted to the steering wheel assembly when secured thereto.

20. The method of claim 16 further comprising the steps of:
positioning a first at least one spring element having a first width about a periphery of a first dampening element;
placing the first dampening element with the first spring element having the first width in a sleeve, and securing the sleeve to a steering wheel core;
measuring vibration of the steering wheel core with the sleeve mounted thereon;
positioning a second at least one spring element having a second width different from the first width about a periphery of a second at least one dampening element, said first at least one dampening element equivalent to said second at least one dampening element;
placing the second at least one dampening element with the second at least one spring element having a second width in a sleeve, and securing the sleeve to a steering wheel core;
measuring vibration of the steering wheel core with the sleeve mounted thereon; and
selecting a width of spring elements for positioning on the dampening element to impart optimal vibration resistance to the steering wheel assembly based on vibrational characteristics imparted to the steering wheel assembly when secured thereto.
